(19) United States
(12) Patent Application Publication
(10) Pub. No.: US 2014/0022279 A1
(43) Pub. Date: Jan. 23, 2014

(54) APPARATUS AND A METHOD FOR PROJECTING AN IMAGE

(71) Applicant: KABUSHIKI KAISHA TOSHIBA, Tokyo (JP)

(72) Inventors: Tsuyoshi Tasaki, Kanagawa-ken (JP); Aira Hotta, Kanagawa-ken (JP); Akihisa Moriya, Kanagawa-ken (JP); Takashi Sasaki, Kanagawa-ken (JP); Haruhiko Okumura, Kanagawa-ken (JP)

(73) Assignee: Kabushiki Kaisha Toshiba, Tokyo (JP)

(21) Appl. No.: 13/856,076

(22) Filed: Apr. 3, 2013

(30) Foreign Application Priority Data
Jul. 17, 2012 (JP) 2012-158904

(51) Int. Cl. G09G 5/377

(52) U.S. Cl. CPC G09G 5/377
USPC 345/629

(57) ABSTRACT

According to one embodiment, an image projection apparatus includes a generation unit, a measurement unit, a change unit, and a projection unit. The generation unit is configured to generate an image to be superimposed on a scene viewed by an observer. The measurement unit is configured to measure a vibration occurred while the observer is moving. The change unit is configured to, when a cycle of the vibration satisfies a predetermined condition, change a figure of the image in a predetermined time so as to lower a visibility of the image. The projection unit is configured to project the image toward eyes of the observer.

### CROSS-REFERENCE TO RELATED APPLICATION

This application is based upon and claims the benefit of priority from Japanese Patent Application No. 2012-158904, filed on Jul. 17, 2012; the entire contents of which are incorporated herein by reference.

### FIELD

Embodiments described herein relate generally to an apparatus and a method for projecting an image.

### BACKGROUND

An image projection apparatus such as a head up display (HUD) or a head mount display (HMD), which projects an index image representing a target position on a scene viewed by an observer, are used. In this image projection apparatus, by reducing a blurring due to vibration occurred while the observer is moving (such as walking or driving a vehicle), the index image had better be accurately projected.

In the image projection apparatus of conventional technique, when the vibration thereof is detected, by shading the index image or by disappearing a part of the index image, the blurring of the index image is reduced. However, the observer often vibrates while he/she is moving. As a result, on the contrary, the index image is hard for the observer to view.

### BRIEF DESCRIPTION OF THE DRAWINGS

FIG. 1 is a block diagram of an image projection apparatus 1 according to the first embodiment.

FIG. 2 is a flow chart of processing of the image projection apparatus 1.

FIG. 3 is one example of a graph measuring a time change of tilt of a head of an observer 100.

FIGS. 4A and 4B are schematic diagrams of a coordinate system on the base of the head of the observer 100.

FIG. 5 is a flow chart of processing of a decision unit 131 in FIG. 1.

FIG. 6 is one example of an experimental result of an apparent movement.

FIG. 7 is a schematic diagram to explain the index image.

### DETAILED DESCRIPTION

According to one embodiment, an image projection apparatus includes a generation unit, a measurement unit, a change unit, and a projection unit. The generation unit is configured to generate an image to be superimposed on a scene viewed by an observer. The measurement unit is configured to measure a vibration occurred while the observer is moving. The change unit is configured to, when a cycle of the vibration satisfies a predetermined condition, change a figure of the image in a predetermined time so as to lower a visibility of the image. The projection unit is configured to project the image toward eyes of the observer.

Various embodiments will be described hereinafter with reference to the accompanying drawings.

### The First Embodiment

An image projection apparatus 1 of the first embodiment is suitable for a head mount display (HMD) attachable to a head of the observer 100, or an AR (augmented reality) glasses.

The image projection apparatus 1 superimposes an index image (For example, an arrow) representing a target position on a scene viewed by the observer 100, and projects the superimposed image. Furthermore, the image projection apparatus 1 generates the index image so that the index image advances to the target position from a view point of the observer 100, and projects the index image generated sequentially.

The image projection apparatus 1 estimates a cycle of vibration of the observer during moving. If the cycle of vibration is within a predetermined range, the image projection apparatus 1 lowers a visibility of the index image for a predetermined time. As a result, blurring of the index image perceived by the observer 100 can be reduced.

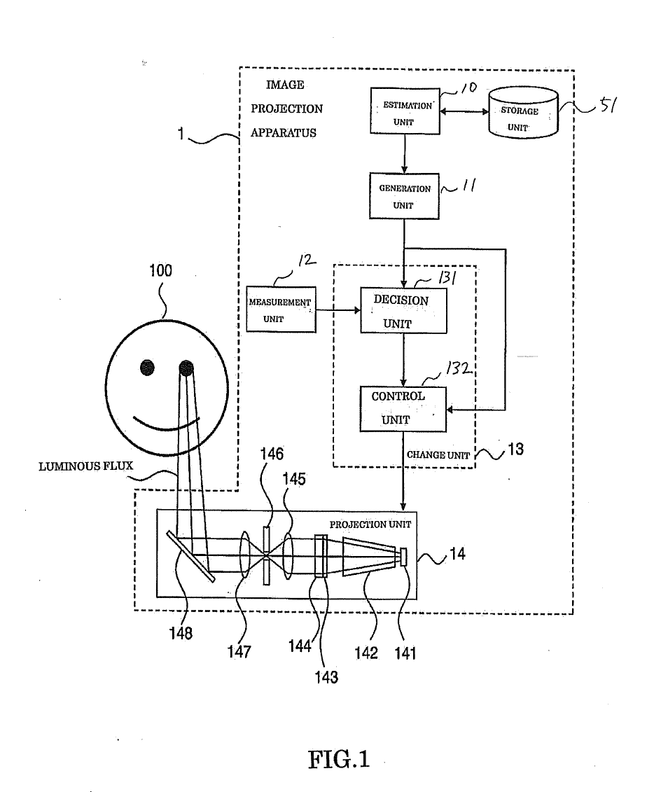

FIG. 1 is a block diagram of the image projection apparatus 1. The image projection apparatus 1 includes an estimation unit 10, a generation unit 11, a measurement unit 12, a change unit 13, a projection unit 14, and a storage unit 51.

The storage unit 51 stores geographical information such as maps.

The estimation unit 10 estimates a present position of the observer 100. For example, by the geographical information stored in the storage unit 51 and a GPS (Global Positioning System), the estimation unit 10 may estimate the present position.

Based on the present position and the geographical information, the estimation unit 10 decides whether the observer 100 is near the target position. For example, the target position may be previously set by the observer 100.

When the observer 100 is near the target position, the generation unit 11 generates an index image sequentially, which is perceived for the observer 100 to advance to the target position. In this case, the generation unit 11 estimates a position and a direction of eyes of the observer 100. From the position and the direction of eyes, the generation unit 11 generates the index image so as to superimpose at the target position.

The measurement unit 12 measures a vibration of the image projection apparatus 1, which is occurred by the observer's moving. In the first embodiment, by detecting a time change of tilt of the observer's head along a lateral direction, the measurement unit 12 measures the vibration. For example, by an accelerometer, the measurement unit 12 may detect the time change of tilt of the observer's head.

The change unit 13 includes a decision unit 131 and a control unit 132. The decision unit 131 decides whether a cycle of the measured vibration satisfies a predetermined condition. Detail explanation thereof is explained afterwards.

If it is decided that the cycle of the measured vibration does not satisfy the predetermined condition, the control unit 132 controls the projection unit 14 to project the index image generated by the generation unit 11.

If it is decided that the cycle of the measured vibration satisfies the predetermined condition, the control unit 132 changes so as to lower a visibility of the index image generated by the generation unit 11. The control unit 132 controls the projection unit 14 to project the changed index image for a predetermined time. Detail explanation thereof is explained afterwards.

By projecting a luminous flux having a shape of the index image toward eyes of the observer 100, the projection unit 14 projects the index image.

As shown in FIG. 1, the projection unit 14 includes a light source 141, a luminous flux limitation unit 142, a diffusion unit 143, an image forming unit 144, a first lens 145, an aperture 146, a second lens 147, and a reflection plate 148.

Assume that respective focal distances of the first lens 145 and the second lens 147 are f1 and f2. Here, the aperture 146 had better be located at a position having a distance f1 from the first lens 145 and a distance f2 from the second lens 147.

A luminous flux outgoing from the light source 141 is incident onto the image forming unit 144 having the diffusion unit 143 on condition that an advance direction of the luminous flux is limited by the luminous flux limitation unit 142. By the diffusion unit 143, the luminous flux is diffused and uniformly incident onto the image forming unit 144. The image forming unit 144 partially penetrates or blocks the luminous flux. As a result, the luminous flux having a shape of the index image is formed.

The luminous flux passed through the image forming unit 144 passes the first lens 145, the aperture 145, and the second lens 147. The luminous flux of which angle of divergence (an extended angle of the luminous flux) is controlled is incident onto the reflection plate 148. The reflection plate 148 reflects the luminous flux toward eyes of the observer 100.

The image forming unit 144 is located at a side of the light source 141 than the aperture 146. Accordingly, in comparison the case that the aperture 146 is located at the side of the light source 141 than the image forming unit 144, a transmittance of the luminous source passing through the image forming unit 144 can be heightened. As a result, power consumption of the light source 141 can be saved.

As the light source 141, a light emitting diode, a high pressure mercury lamp, a halogen lamp, or a laser, can be used. As the luminous flux limitation unit 142, a light guide with tapered part can be used. As the diffusion unit 143, a diffusion filter or a diffusion plate can be used. As the image forming unit 144, a liquid crystal display or a digital mirror device can be used.

The estimation unit 10, the generation unit 11, the measurement unit 12, and the change unit 13, may be realized as Central Processing Unit (CPU) and a memory used by the CPU. The storage unit 51 may be realized as a memory used by the CPU, or an auxiliary memory.

Thus far, component of the image projection apparatus 1 is already explained.

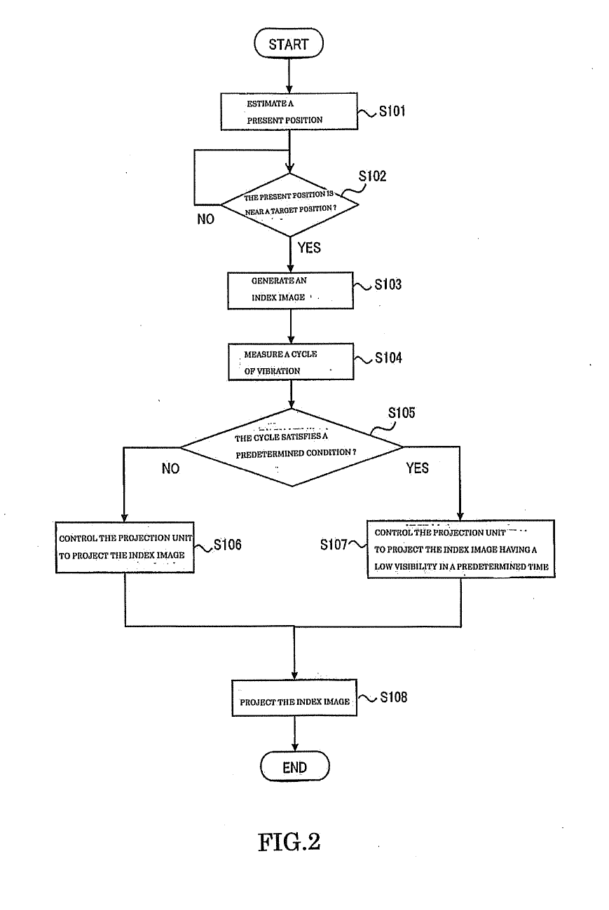

FIG. 2 is a flow chart of processing of the image projection apparatus 1. The estimation unit 10 estimates the present position of the observer 100 (S101). Based on the present position estimated and geographical information, the estimation unit 10 decides whether the observer 100 is near the target position (S102). For example, if a distance from the observer 100 to the target position is smaller than a predetermined threshold, the estimation unit 10 decides that the observer 100 is near the target position.

If the estimation unit 10 decides that the observer 100 is not near the target position (No at S102), the estimation unit 10 continues decision processing of S102 until the observer 100 is near the target position.

If the estimation unit 10 decides that the observer 100 is near the target position (Yes at S102), the generation unit 11 generates an index image sequentially, which is perceived for the observer 100 to advance to the target position (S103).

The measurement unit 12 measures a cycle of vibration of the image projection apparatus 1, which is occurred by the observer's moving (S104).

The decision unit 131 decides whether the measured cycle of vibration satisfies a predetermined condition (S105).

If the decision unit 131 decides that the cycle does not satisfy the predetermined condition (No at S105), the control unit 132 controls the projection unit 14 to project the index image generated by the generation unit 11 (S106).

If the decision unit 131 decides that the cycle satisfies the predetermined condition (Yes at S105), the control unit 132 changes to lower a visibility of the index image generated by the generation unit 11. The control unit 132 controls the projection unit 14 to project the changed index image for a predetermined time (S107).

By projecting a luminous flux having a shape of the index image toward eyes of the observer 100, the projection unit 14 projects the index image (S108), and entire processing is completed.

Thus far, processing of the image projection apparatus 1 is already explained.

Hereinafter, detail processing of the first embodiment will be explained.

The measurement unit 12 includes a sensor (tilt sensor) to measure a time change of tilt of the observer's head. As the tilt sensor, for example, an accelerometer can be used. Briefly, by using the tilt sensor, the measurement unit 12 measures a time change of rotation angle of the observer's head along the lateral direction (direction of right and left).

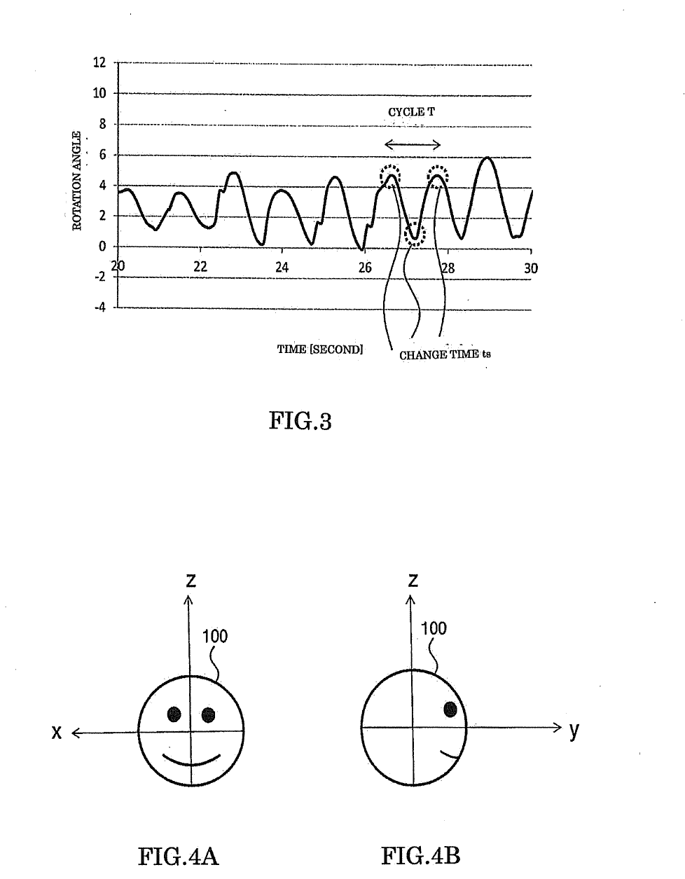

FIG. 3 is one example of a measurement graph of the time change of tilt of the observer's head. In FIG. 3, a horizontal axis represents a time, and a vertical axis represents a rotation angle of the observer's head along the lateral direction (direction of right and left). FIGS. 4A and 4B are schematic diagrams of a coordinate system on the base of the observer's head. If the coordinate system shown in FIGS. 4A and 4B is defined, the horizontal axis of the measurement graph shown in FIG. 3 represents a rotation angle along y-axis.

By using a rotation angle along y-axis acquired from the tilt sensor, the measurement unit 12 detects a change time ts when a direction of the rotation angle has changed. For example, as shown in FIG. 4B, while the observer's head is tilting along his/her advance direction (y-axis direction), when the head's tilt to a right side (or a left side) along the advance direction has reversely changed to the left side (or the right side), this change time is detected. Briefly, the change time tₛ is a time corresponding to “peak” or “bottom” in a waveform of the measurement graph shown in FIG. 3. As a start time for the control unit 132 to change a figure of the index image in a predetermined time, the measurement unit 12 uses the change time tₛ. For example, the measurement unit 12 may calculate a time satisfying a following equation (1) as the change time tₛ.

(r(tₛ)−r(tₛ−Δₜ))×(r(tₛ+Δₜ)−r(tₛ))<0 (1)

In the equation (1), r (tₛ) represents a rotation angle of the observer's head at the change time tₛ, and Δt represents a very little time previously set.

Moreover, a time when a predetermined period has elapsed from the change time iₛ may be a new change time tₛ. Furthermore, a change point along axis except for y-axis may be the change time tₛ. Furthermore, except for the tilt sensor, the measurement unit 12 may use a motion sensor to detect a moving of the observer's foot. In this case, the measurement unit 12 may detect a time when the observer's foot is landing as the change time tₛ.

The measurement unit 12 calculated a cycle T from a difference between the change time tₛ and a previous change time tₛ. The measurement unit 12 supplies the change time tₛ and the cycle T to the decision unit 131 and the control unit 132.

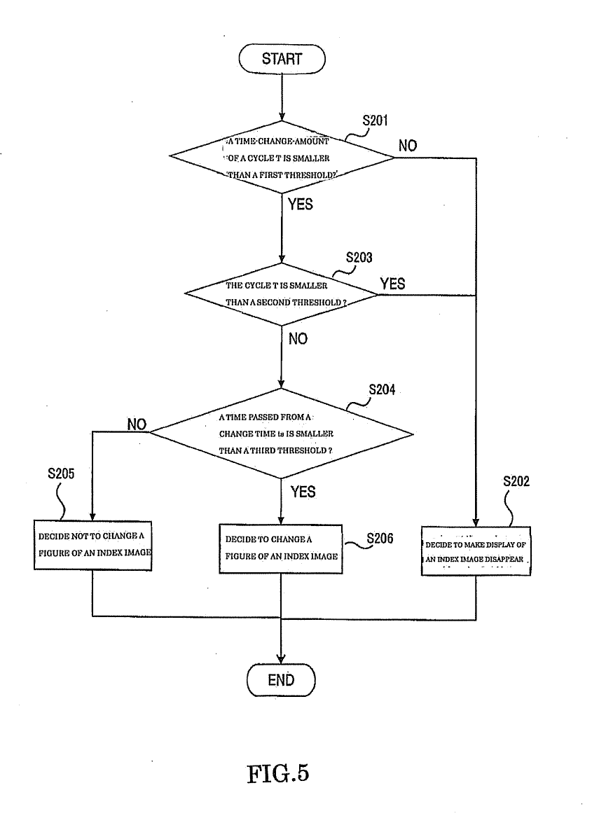

FIG. 5 is a flow chart of processing of the decision unit 131. The decision unit 131 decides whether a degree (time-change-amount) of time change of the cycle T is smaller than a predetermined threshold (first threshold) (S201). If the decision of S201 is NO, the decision unit 131 decides to make a display of the index image disappear (202).

If the decision of S201 is YES, the decision unit 131 decides whether the cycle T is smaller than a predetermined threshold (second threshold) (S203). If the decision of S203 is YES, processing is transited to S202.

If the decision of S203 is NO, the decision unit 131 decides whether an elapsed time from the change time tₛ to the present time is smaller than a predetermined threshold (third threshold) (S204).

If the decision of S204 is NO, the decision unit 131 decides not to change a figure of the index image (S205). If the decision of S204 is YES, the decision unit 131 decides to change the figure of the index image so as to lower a visibility of the index image (S206).

In the case that the decision unit 131 decides to change the figure of the index image so as to lower a visibility of the index image, processing of the control unit 132 is explained hereinafter.

The control unit 132 changes a figure of the index image so as to lower a visibility of the index image for a predetermined period from the change time tₛ. For example, by lowering a brightness of the index image, the control unit 132 may lower the visibility thereof. Alternatively, by disappearing a part of the index image, the control unit 132 may lower the visibility thereof.

The predetermined period may be set as a time segment in which an apparent movement occurs. The apparent movement represents, even if an object (the target image in the first embodiment) disappears, a movement for a person to view as if the object is moving under an illusion of the person's eyes. In general, a limit time to occur the apparent movement is approximately 200 milliseconds.

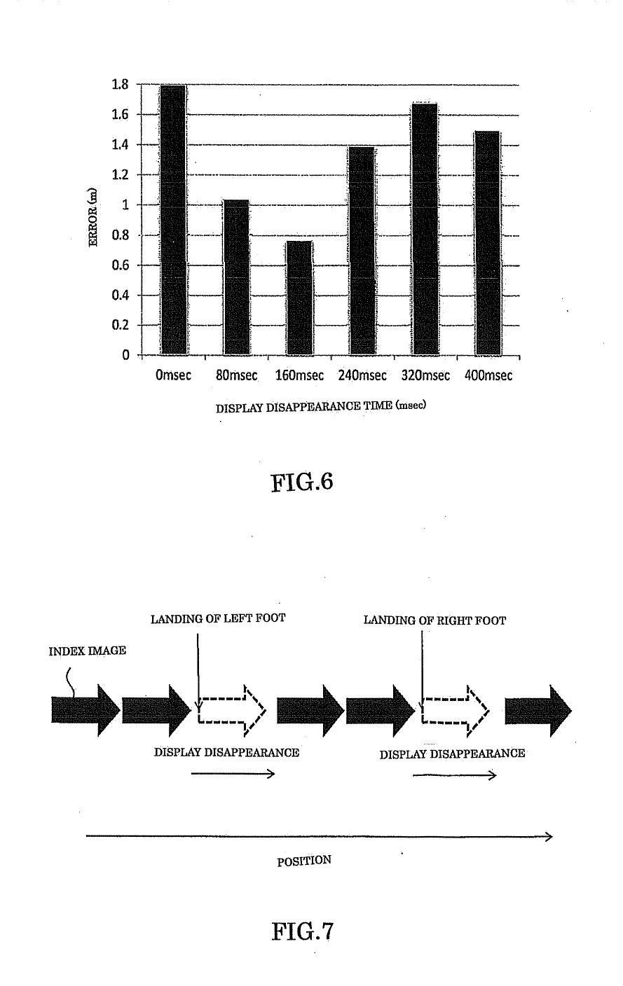

FIG. 6 is one example of a graph showing an experimental result of the apparent movement. While the index image to be moved is disappeared in “display disappearance time”, a position where the observer 100 illusively views the index image is detected. On the other hand, while the index image is not disappeared, a position where the observer 100 actually views the index image is detected. An error between these two positions is measured for a plurality of test subjects. FIG. 6 shows this experimental result. In FIG. 6, by disappearing the index image in a period from 0 millisecond to 200 milliseconds, it is understood that the error between a position where the observer 100 illusively views the index image and a position where the observer 100 actually views the index image is few.

The control unit 132 changes a figure of the index image to lower a visibility thereof in a predetermined time, and supplies the index image of which the figure is changed to the projection unit 14. Moreover, after a predetermined time has elapsed, the control unit 14 supplies the index image of which the figure is not changed to the projection unit 14. Furthermore, if the cycle of vibration is smaller than a predetermined threshold, the control unit 132 may supply the index image of which figure is changed to lower the visibility to the projection unit 14. Furthermore, by storing the cycle of vibration in time series, if a time when a difference between two cycles adjacent in time series is smaller than a predetermined threshold does not continue over a predetermined period, the control unit 132 may supply the index image of which figure is changed to lower the visibility to the projection unit 14.

FIG. 7 is a schematic diagram to explain the index image (having a low visibility) projected in time series. For example, by disappearing the index image from a time when a left foot or a right foot of the observer is landing, the index image easy for the observer to view can be projected.

As mentioned-above, according to the present embodiment, the index image can be superimposed onto a scene with high accuracy. As a result, the index image easy for the observer to view can be projected.

Moreover, in the present embodiment, the index image is already explained on the assumption that an object to be displayed is used for navigation. However, as to an object displayed with augmented reality at a specific position in a real world, such as an electronic pet or a play equipment for entertainment, the index image can be applied.

In the disclosed embodiments, the processing can be performed by a computer program stored in a computer-readable medium.

In the embodiments, the computer readable medium may be, for example, a magnetic disk, a flexible disk, a hard disk, an optical disk (e.g., CD-ROM, CD-R, DVD), an optical magnetic disk (e.g., MD). However, any computer readable medium, which is configured to store a computer program for causing a computer to perform the processing described above, may be used.

Furthermore, based on an indication of the program installed from the memory device to the computer, OS (operating system) operating on the computer, or MW (middle ware software), such as database management software or network, may execute one part of each processing to realize the embodiments.

Furthermore, the memory device is not limited to a device independent from the computer. By downloading a program transmitted through a LAN or the Internet, a memory device in which the program is stored is included. Furthermore, the memory device is not limited to one. In the case that the processing of the embodiments is executed by a plurality of memory devices, a plurality of memory devices may be included in the memory device.

A computer may execute each processing stage of the embodiments according to the program stored in the memory device. The computer may be one apparatus such as a personal computer or a system in which a plurality of processing apparatuses are connected through a network. Furthermore, the computer is not limited to a personal computer. Those skilled in the art will appreciate that a computer includes a processing unit in an information processor, a microcomputer, and so on. In short, the equipment and the apparatus that can execute the functions in embodiments using the program are generally called the computer.

While certain embodiments have been described, these embodiments have been presented by way of examples only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An apparatus for projecting an image, comprising:
a generation unit configured to generate an image to be superimposed on a scene viewed by an observer;
a measurement unit configured to measure a vibration occurred while the observer is moving;
a change unit configured to, when a cycle of the vibration satisfies a predetermined condition, change a figure of the image in a predetermined time so as to lower a visibility of the image; and
a projection unit configured to project the image toward eyes of the observer.

2. The apparatus according to claim 1, wherein
the generation unit generates an index image moving sequentially to a target position to be indicated to the observer; and
the projection unit projects the index image toward the eyes of the observer.

3. The apparatus according to claim 2, wherein,
when the cycle of the vibration satisfies the predetermined condition,
the change unit changes the figure of the index image within a time range while the index image is perceived as an apparent movement.

4. The apparatus according to claim 3, wherein
the measurement unit measures a time change of a tilt of the observer along a lateral direction of the observer, as the vibration.

5. The apparatus according to claim 1, wherein,
when a time-change-amount of the cycle is smaller than a first threshold,
when the cycle is larger than a second threshold, and
when an elapsed time from a specific time in the cycle is smaller than a third threshold,
the change unit changes the figure of the image in the predetermined time so as to lower the visibility of the image.

6. A method for projecting an image, comprising:
generating an image to be superimposed on a scene viewed by an observer;
measuring a vibration occurred while the observer is moving;
when a cycle of the vibration satisfies a predetermined condition, changing a figure of the image in a predetermined time so as to lower a visibility of the image; and
projecting the image toward eyes of the observer.
